(19) United States
(12) Patent Application Publication
(10) Pub. No.: US 2021/0309030 A1
(43) Pub. Date: Oct. 7, 2021

(54) HINGE ASSEMBLY

(71) Applicant: Hewlett-Packard Development Company, L.P., Spring, TX (US)

(72) Inventor: Shuang-Kun Zhu, Shanghai (CN)

(73) Assignee: Hewlett-Packard Development Company, L.P., Spring, TX (US)

(21) Appl. No.: 17/262,376

(22) PCT Filed: Nov. 9, 2018
(86) PCT No.: PCT/CN2018/114696

§ 371 Date: Jan. 22, 2021

(51) Int. Cl. B41J 29/02; E05D 11/10; F16C 11/04

(52) U.S. Cl. CPC B41J 29/02; E05Y 2900/606; F16C 11/04; E05D 11/1064

(57) ABSTRACT

A hinge assembly (100), comprises a ratchet structure which includes a hinge slider (106) and a hinge arm (110). The hinge arm (110) is to engage with the hinge slider (106) when a component coupled to the hinge assembly (100) is in an open position and disengage from the hinge slider (106) when the component is in a closed position.

### BACKGROUND

A hinge is a mechanical bearing that connects two objects that may allow a limited angle of rotation between the two objects. Two objects connected by a hinge may rotate relative to each other about a fixed axis of rotation with other translations or rotations being prevented resulting in the hinge has one degree of freedom. Hinges may be made of flexible material or of moving components.

### BRIEF DESCRIPTION OF THE DRAWINGS

FIG. 1 illustrates a diagram of an example hinge assembly according to the present disclosure.

FIG. 2 illustrates a diagram of an example hinge assembly when a component coupled to the hinge assembly is in an open position according to the present disclosure.

FIG. 3 illustrates another diagram of an example hinge assembly when a component coupled to the hinge assembly is in an open position according to the present disclosure.

FIG. 4 illustrates a diagram of an example hinge assembly when a component coupled to the hinge assembly is in a closed position according to the present disclosure.

FIG. 5 illustrates another diagram of an example hinge assembly when a component coupled to the hinge assembly is in a closed position according to the present disclosure.

FIG. 6 illustrates an exploded view of an example hinge assembly when a component coupled to the hinge assembly is in an open position according to the present disclosure.

FIG. 7 illustrates a diagram of an example hinge case and hinge slider according to the present disclosure.

FIG. 8 illustrates a diagram of an example hinge case and hinge arm according to the present disclosure.

FIG. 9 illustrates a diagram of an example hinge assembly including a hinge pin according to the present disclosure.

FIG. 10 illustrates a diagram of an example hinging method according to the present disclosure.

### DETAILED DESCRIPTION

Hinging assemblies include components that are part of a hinge that work together to make the hinge function. For instance, in a barrel hinge, the hinging assembly includes a section barrel secured by a pivot. The barrel component has a hollow cylinder-shaped section where the rotational bearing force is applied to the pivot. These different components (e.g., barrel, pivot, etc.) make up the hinge assembly and work together to make the hinge function.

Printing devices (e.g., printers, scanners, copy machines, multi-functional printers, all-in-one printers, etc.) may use hinging assemblies to couple different components allowing for movement between the different components. As used herein, coupling includes directly or indirectly connecting components. For instance, a printing device may be coupled to a hinging assembly, and the hinging assembly may be coupled to a component. In the same example, the printing device is coupled to the component (e.g., indirectly via the hinging assembly). For instance, an all-in-one printing device can include an integrated scanning apparatus (ISA) coupled to the printing device for use in copying, scanning, etc. The ISA can be coupled to the printing device via a hinge assembly.

Some approaches to coupling printing device components to a printing device can include the use of vertical hinge assemblies. For instance, in such an approach, a hinge arm makes a hinge slider move in a vertical direction. For this type of hinge assembly, penetration of an engine of the printing device may occur. To avoid this penetration and risk of engine damage, some approaches keep the vertical hinge assembly away from engine components by creating a pocket feature outside of the engine to accommodate the hinge assembly. This results in a bulky, visually displeasing exterior of the printing device. In addition, because the hinge assembly is outside of the engine, the arm of the component's gravity is bigger, resulting in such approaches using a larger torque from the hinge assembly to overcome the component's torque in order for a component to be stable when in an open position.

In contrast, examples of the present disclosure include a horizontal hinge assembly. Some examples can use a ratchet structure (e.g., a hinge slider/hinge arm combination) to transform the component's rotation into a hinge slider's motion in the horizontal direction. For instance, when the component is in an open position, the ratchet structure engages, allowing for the component to remain in an open position until acted on by an outside closing force. The ratchet structure, in some instance, facilitates transformation of a vertical gravitation force to a horizontal force, as will be described further herein.

Such a hinge assembly can be placed in an area between the component and the printing device engine, meaning the hinge assembly is not located outside of the engine, resulting in a cleaner, more visually pleasing printing device. Because the hinge assembly is horizontal, interference between the hinge assembly and the engine's internal components may be reduced and/or eliminated.

Additionally, in some examples, the arm of the component's gravity force is smaller as compared to the same in a vertical hinge assembly. As a result, a smaller hinge spring force can be used to overcome the component's torque as compared to the same in a vertical hinge assembly. Smaller spring forces can result in reduced risk of hinge case damage. Because the spring force is reduced, some examples of the present disclosure can include a hinge case comprising a polycarbonate (PC) material rather than a glass fiber (GF) material or PC/GF material combination, resulting in reduced costs of the hinge assembly as compared to a vertical hinge assembly, which may not support a PC material hinge case.

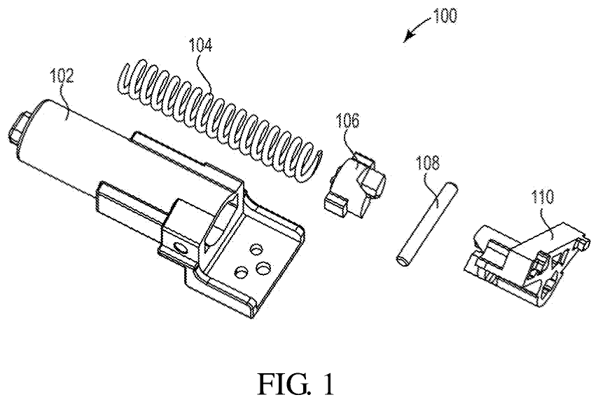

The figures herein follow a numbering convention in which the first digit corresponds to the drawing figure number and the remaining digits identify an element or component in the drawing. For example, reference numeral 102 refers to element “02” in FIG. 1 and an analogous element may be identified by reference numeral 302 in FIG. 3. Elements shown in the various figures herein can be added, exchanged, and/or eliminated so as to provide a number of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

FIG. 1 illustrates a diagram of an example hinge assembly 100 according to the present disclosure. Hinge assembly 100 can operate in a horizontal position, and may be located, for instance, between a printing device and a component, such as an ISA. For instance, a space may exist between the printing device and the component in which hinge assembly 100 can operate. Hinge assembly 100 can include hinge arm 110, hinge pin 108, hinge slider 106, and hinge spring 104. Hinge case 102 can house hinge spring 104, hinge slider 106, hinge pin 108, and a portion of hinge arm 110, in some examples.

Hinge assembly 100, as will be described further herein, can include a ratchet structure made up of hinge slider 106 and hinge arm 110 such that hinge arm 110 engages with hinge slider 106 when a component coupled to hinge assembly 100 is in an open position and disengages from hinge slider 106 when the component is in a closed position. In some examples, the ratchet structure allows for the component to remain in the open position until acted upon by an outside force to close the component (e.g., until a user closes an ISA coupled to a printing device). The ratchet structure, in some instance, can also facilitate transformation of a vertical gravitation force to a horizontal force, as will be described further herein.

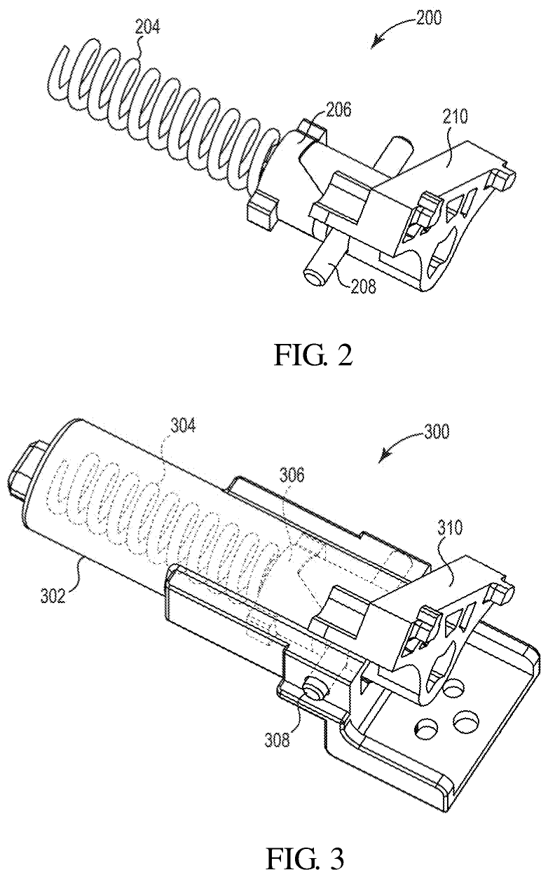

FIG. 2 illustrates a diagram of an example hinge assembly 200 when a component coupled to the hinge assembly 200 is in an open position according to the present disclosure. When the component is in an open position, the ratchet structure including hinge slider 206 and hinge arm 210 engage (e.g., like a gear). As will be discussed further herein, spring 204 can generate a spring force to counteract movement of hinge slider 206 when the component is in the open position such that the component retains its open position. As will also be discussed further herein, hinge pin 208 can restrict movement of hinge arm 210 when the component is in the open position.

FIG. 3 illustrates another diagram of an example hinge assembly 300 when a component coupled to the hinge assembly 300 is in an open position according to the present disclosure. FIG. 3 illustrates hinge assembly 300 components housed within hinge case 302. Hinge case 302 can house hinge spring 304, hinge slider 306, hinge pin 308, and a portion of hinge arm 310, in some examples. A portion of hinge pin 308 may extend out of hinge case 302 in some instances.

When the component is in an open position, the ratchet structure including hinge slider 306 and hinge arm 310 engage, and hinge spring 304 can generate a spring force to counteract movement of hinge slider 306. In some examples, hinge pin 308 can restrict movement of hinge arm 310 when the component is in the open position.

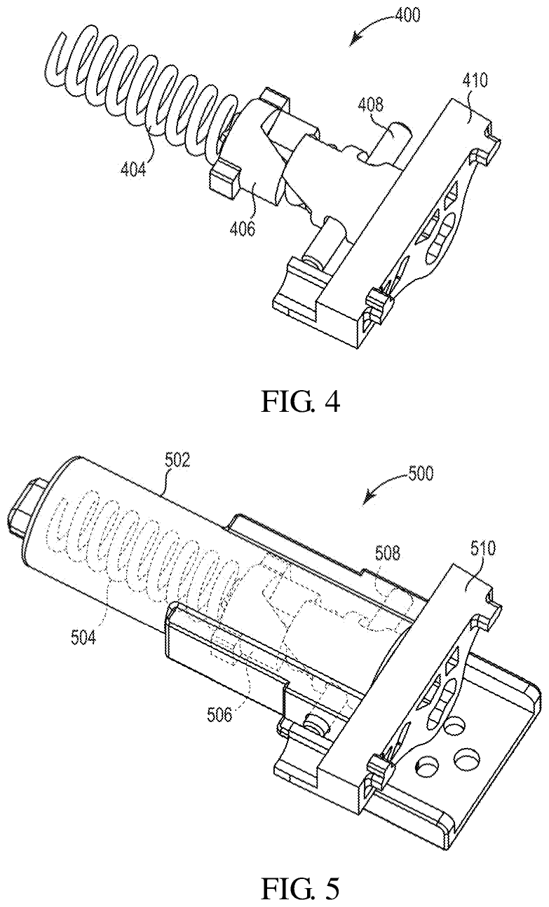

FIG. 4 illustrates a diagram of an example hinge assembly 400 when a component coupled to the hinge assembly 400 is in a closed position according to the present disclosure. When the component is closing, hinge arm 410 can rotate, and hinge slider 406 can move horizontally, resulting in disengagement of the ratchet structure. Hinge arm 410 and hinge slider 406 may touch one another, but their ratchet structure is disengaged when the component is in a closed position. Hinge pin 408 and hinge spring 404, while present, may not counteract a force of hinge arm 401 or hinge slider 406, as a gravity force of the component is no longer acting on hinge assembly 400.

FIG. 5 illustrates another diagram of an example hinge assembly 500 when a component coupled to the hinge assembly 500 is in a closed position according to the present disclosure. FIG. 5 illustrates hinge assembly 500 components housed within hinge case 502. Hinge case 502 can house hinge spring 504, hinge slider 506, hinge pin 508, and a portion of hinge arm 510, in some examples. A portion of hinge pin 508 may extend out of hinge case 502 in some instances. When the component is in a closed position, hinge arm 510 is in a different position than when the component is in an open position (e.g., as illustrated in FIGS. 2 and 3). When the component is in a closed position, the ratchet structure of hinge slider 506 and hinge arm 510 is disengaged.

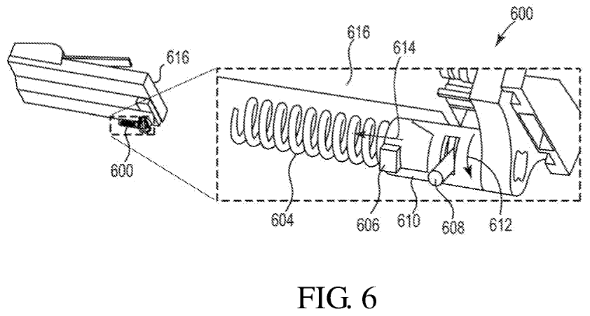

FIG. 6 illustrates an exploded view of an example hinge assembly 600 when a component 616 coupled to the hinge assembly 600 is in an open position according to the present disclosure. Hinge assembly 600 can transform the component's rotation (e.g., it's gravitational force) into a hinge slider's motion in the horizontal direction. For instance, component 616, which can include an ISA in some examples, is in an open position, such that its gravity force makes hinge arm 610 rotate in direction 612. As a result, hinge slider 606 moves in a horizontal direction 614. Hinge spring 604 can generate a spring force to counteract (e.g., stop) the movement of hinge slider 606. The springe force can hold the component stably. For instance, an ISA coupled to a printing device via hinge assembly 600 can be held in an open position until acted upon by an outside force (e.g., user closing the ISA). As illustrated in FIG. 6, hinge assembly can be housed in an open space between component 616 and a printing device, in some examples.

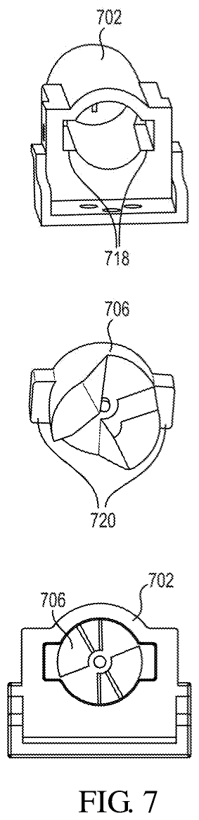

FIG. 7 illustrates a diagram of an example hinge case 702 and hinge slider 706 according to the present disclosure. In some examples, hinge slider 706 moves horizontally within hinge case 702 using a groove-protrusion combination. For instance, hinge case 702 includes groove features 718 to guide hinge slider 706 to move horizontally inside of hinge case 702. Hinge slider 706 includes protrusion features 720 to constrain rotation of hinge slider 706 while it moves horizontally inside hinge case 706. For instance, groove features 718 engage with protrusion features 720 (e.g., protrusion features 720 slide along groove features 718) restricting rotation of hinge slider 706 within hinge case 702. While two groove features 718 and two protrusion features 720 are illustrated in FIG. 7, more or fewer protrusion features and/or groove features may be present.

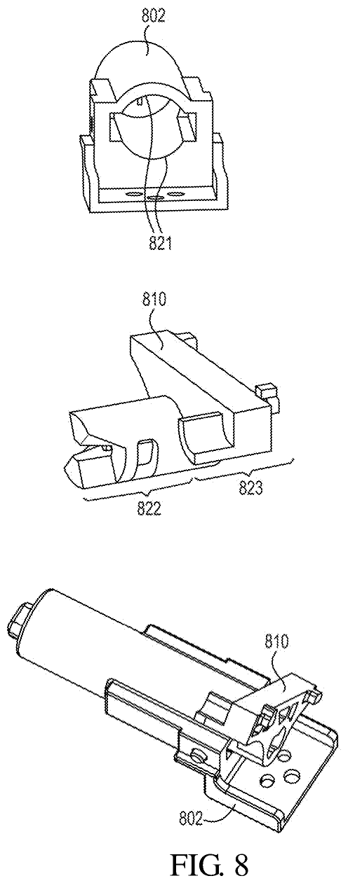

FIG. 8 illustrates a diagram of an example hinge case 802 and hinge arm 810 according to the present disclosure. A portion (e.g., circular shaft 822) of hinge arm 810 can rotate within hinge case 802 while a different portion 823 of hinge arm 810 remains outside of hinge case 802. For instance, hinge case 802 can have a circular interior that allows for rotation of hinge arm 810 within hinge case 802 because of the circular shaft 822 of hinge arm 810.

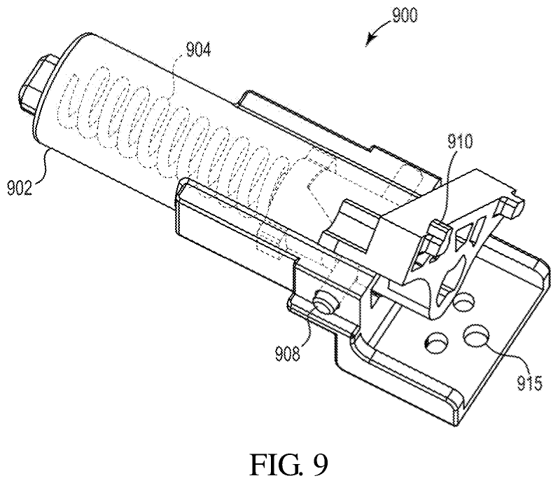

FIG. 9 illustrates a diagram of an example hinge assembly 900 including a hinge pin 908 according to the present disclosure. In the example illustrated in FIG. 9, a component coupled to a printing device via hinge pin 900 is in an open position. Hinge pin 908 can restrain horizontal movement of hinge arm 910 such that rotation of components of hinge assembly 900 is restricted to the inside of hinge case 902. Hinge spring 904 is compressed and a resulting spring force make hinge arm 910 tend to move outside the case, but hinge pin 908 restricts (e.g., stops) this movement. Hinge pin 908, in some instance, restricts rotation of hinge arm 910 outside of the hinge case. Hinge pin 908, in some instances, protrudes outside of hinge case 902. Hinge pin 908 may be a metal material, but other materials may be used in some instances.

Hinge assembly 900 can be fixed to a printing device using hole 915. For instance, a fastening device, such as an M4 or other screw can be used to connect hinge assembly 900 to a top cover of a printing device engine. The component (e.g., an ISA) can be coupled to hinge arm 910 of hinge assembly via a fastening device or may interlock with a portion of the component, in some examples. For instance, hinge assembly 900 can couple an ISA to a printing device such that the ISA can be adjusted (e.g., opened and closed) via hinge assembly 900.

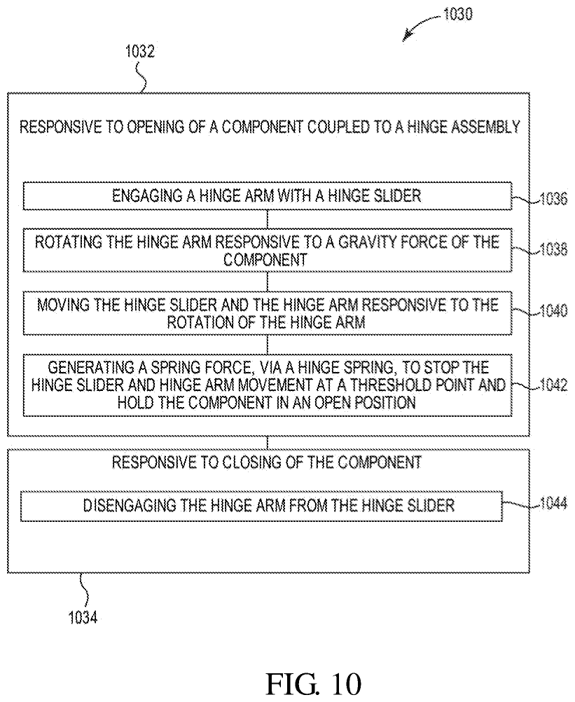

FIG. 10 illustrates a diagram of an example hinging method 1030 according to the present disclosure. At 1032, method 1030 can include actions occurring responsive to an opening of a component coupled to a hinge assembly. For instance, at 1036, method 1030 includes engaging a hinge arm with a hinge slider. For instance, this can include an engagement such that the hinge arm and the hinge slider form a ratchet structure.

At 1038, method 1030 can include rotating the hinge arm responsive to a gravity force of the component. For instance, when the component is in an open position, its gravity force may make the hinge arm tend to rotate in a particular direction. Responsive to this, method 1030 can include moving the hinge slider and the hinge arm. For instance, the hinge slider may tend to move away from the hinge arm. During opening, in some examples, a rotation of the component is transformed to a rotation (and resulting horizontal movement) of the hinge slider.

Responsive to the movement of the hinge slider, method 1030 can include generating a spring force, via a hinge spring, to stop the hinge slider and hinge arm movement at a threshold point and hold the component in an open position. For instance, the hinge spring can generate a spring force to restrict movement of the hinge slider and hinge arm such that the component is held stably until an outside force is applied to the component. The threshold point can include a particular point that allows for a spring force great enough to stably hold the component in the open position.

At 1034, method 1030 can include actions occurring responsive to a closing of the component. For instance, at 1044, method 1030 can include disengaging the hinge arm from the hinge slider. For instance, the hinge arm can rotate, and the hinge slider can move horizontally, disengaging the ratchet structure formed during opening. In some examples, the hinge arm and the hinge slider can remain touching when the component is in the closed position.

During opening and closing of the component, the hinge slider and hinge arm can be moved within a hinge case housing the hinge arm, the hinge slider, and the hinge spring.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

1. A hinge assembly, comprising:
a ratchet structure, comprising:
a hinge slider; and
a hinge arm to:
engage with the hinge slider when a component coupled to the hinge assembly is in an open position; and
disengage from the hinge slider when the component is in a closed position.

2. The hinge assembly of claim 1, wherein the hinge assembly operates in a horizontal configuration.

3. The hinge assembly of claim 1, further comprising a hinge case housing the ratchet structure.

4. The hinge assembly of claim 1, further comprising a hinge spring to counteract a force of the hinge slider on the spring when the component is in the open position.

5. The hinge assembly of claim 1, wherein the component is an integrated scanner assembly and the hinge assembly couples the integrated scanner assembly to a printing device.

6. A horizontal hinge assembly, comprising:
a hinge case housing:
a hinge spring;
a hinge slider; and
a portion of a hinge arm,
wherein the hinge arm is to engage with the hinge slider when a component coupled to the hinge assembly is in an open position;
wherein the hinge spring is to counteract a force of the hinge slider on the spring when the component is in the open position such that the component retains its open position; and
wherein the hinge arm is to disengage with the hinge slider when a component coupled to the hinge assembly is in a closed position.

7. The hinge assembly of claim 6, wherein the hinge assembly is housed within a space between the component and a printing device engine.

8. The hinge assembly of claim 6, further comprising a hinge pin to:
restrain movement of the hinge arm in a horizontal direction; and
restrict rotation of the hinge arm outside of the hinge case.

9. The hinge assembly of claim 6, wherein the hinge slider comprises a protrusion feature to constrain rotation of the hinge slider within the hinge case and facilitate horizontal movement of the hinge slider within the hinge case.

10. The hinge assembly of claim 9, wherein the hinge case comprises a groove to receive the protrusion feature.

11. The hinge assembly of claim 6, wherein the component is an integrated scanning assembly, and the hinge assembly couples a printing device to the integrated scanning assembly such that the integrated scanning assembly can be adjusted via the hinge assembly.

12. The hinge assembly of claim 6, wherein the hinge case comprises a polycarbonate material.

13. A hinging method, comprising:
responsive to opening of a component coupled to a hinge assembly:
engaging a hinge arm with a hinge slider;
rotating the hinge arm responsive to a gravity force of the component;
moving the hinge slider and the hinge arm responsive to the rotation of the hinge arm; and
generating a spring force, via a hinge spring, to stop the hinge slider and hinge arm movement at a threshold point and hold the component in an open position; and
responsive to closing of the component:
disengaging the hinge arm from the hinge slider.

14. The hinging method of claim 13, further comprising transforming a rotation of the component to a rotation of the hinge slider when the component is in the open position.

15. The hinging method of claim 13, further comprising moving the hinge slider and the hinge arm within a hinge case housing the hinge arm, the hinge slider, and the hinge spring.
